(19) United States
(12) Patent Application Publication
(10) Pub. No.: US 2013/0000588 A1
(43) Pub. Date: Jan. 3, 2013

(54) VALVE STEM SEAL FOR A COMBUSTION ENGINE

(75) Inventors: Hartmut Bartel, Altenholz (DE); Hendrik Herold, Kiel (DE); Ole Ehlert, Altenholz (DE); Ulrich Holst, Tuttendorf (DE); Jan Rodenbeck, Bornhoved (DE)

(73) Assignee: Caterpillar Motoren GmbH & Co. KG, Kiel (DE)

(21) Appl. No.: 13/537,286

(22) Filed: Jun. 29, 2012

(30) Foreign Application Priority Data
Jun. 29, 2011 (EP) 11171882

(51) Int. Cl. F01L 3/08; F02F 11/00; B21K 3/00

(52) U.S. Cl. 123/188.6; 29/888.01; 277/502

(57) ABSTRACT

A valve stem seal (10) for a combustion engine may comprise a cylindrical body (12) including a mounting portion (16) and a valve stem sealing portion (14) integrally formed with the mounting portion (16), and an o-ring (26) configured for sealing engagement with a valve stem reciprocating in a valve guide (40) of a valve of the combustion engine. The mounting portion (16) may define an opening (18) for receiving an upper end (43) of the valve guide (40) and may be configured for substantially fluid-tight engagement with the upper end (43) of the valve guide (40). The valve stem sealing portion (14) may include an annular groove (22) formed in an inner surface of the cylindrical body (12). The o-ring (26) may be received in the annular groove.

### CROSS-REFERENCE TO RELATED APPLICATION

This application claims the benefit of prior patent application Serial No. EP11171882, filed Jun. 29, 2011.

### TECHNICAL FIELD

The present disclosure generally relates to a valve stem seal and, more particularly, to a valve stem seal for a valve of a combustion engine.

### BACKGROUND

In valve assemblies of combustion engines, in particular, inlet or exhaust valves of a combustion engine, lubricant such as, e.g., oil, is supplied to a valve guide and a valve stem movably disposed in the valve guide via a valve stem seal to inhibit wear. For example, a double lip seal may be used. Examples of valve stem seals are disclosed, for example, in U.S. Pat. No. 5,110,142 and U.S. Pat. No. 4,834,037.

In these known valve stem seals, the amount of lubricant entering the valve guide may not be sufficient to provide correct lubrication for the valve of the combustion engine over the life of the engine. For example, after extended periods of operating the engine, undesired wear of the valve guide and/or the valve stem may occur, effecting operation of the combustion engine and potentially leading to damaging of components of the same.

The present disclosure is directed, at least in part, to improving or overcoming one or more aspects of prior systems.

### SUMMARY OF THE DISCLOSURE

According to one aspect of the disclosure, a valve stem seal for a combustion engine may comprise a cylindrical body including a mounting portion and a valve stem sealing portion integrally formed with the mounting portion, and an o-ring configured for sealing engagement with a valve stem reciprocating in a valve guide of a valve of the combustion engine. The mounting portion may define an opening for receiving an upper end of the valve guide and may be configured for substantially fluid-tight engagement with the upper end of the valve guide. The valve stem sealing portion may include an annular groove formed in an inner surface of the cylindrical body. The o-ring may be received in the annular groove.

According to another aspect of the present disclosure, a combustion engine may comprise an engine block at least partially defining a plurality of cylinders, each of the plurality of cylinders being associated with at least one inlet valve and at least one exhaust valve, and a valve stem seal attached to at least one of the inlet or exhaust valves of the plurality of cylinders. The valve stem seal may comprise a cylindrical body including a mounting portion and a valve stem sealing portion integrally formed with the mounting portion, and an o-ring configured for sealing engagement with a valve stem reciprocating in a valve guide of an inlet or exhaust valve. The mounting portion may define an opening for receiving an upper end of the valve guide and may be configured for substantially fluid-tight engagement with the upper end of the valve guide. The valve stem sealing portion may include an annular groove formed in an inner surface of the cylindrical body. The o-ring may be received in the annular groove.

According to another aspect of the present disclosure, a method of adjusting lubrication of an inlet or exhaust valve in a combustion engine, the inlet or exhaust valve including a valve guide and a valve stem slidably disposed in the valve guide, may comprise removing a first valve stem seal from the upper end of the valve guide, the first valve stem seal being configured to allow a first amount of lubricant to enter the valve guide during reciprocation of the valve stem, and attaching a second valve stem seal to the upper end of the valve guide, the second valve stem seal being configured to allow a second amount of lubricant that is greater than the first amount to enter the valve guide during reciprocation of the valve stem, thereby increasing an amount of lubricant in the valve guide.

According to another aspect of the present disclosure, a retrofitting method for a combustion engine having a plurality of cylinders, each of the plurality of cylinders being associated with at least one inlet valve and at least one exhaust valve, may comprise attaching a valve stem seal to a valve guide of one of the at least one inlet valve and the at least one exhaust valve. The valve stem seal may comprise a cylindrical body including a mounting portion and a valve stem sealing portion integrally formed with the mounting portion, and an o-ring configured for sealing engagement with a valve stem reciprocating in a valve guide of an inlet or exhaust valve. The mounting portion may define an opening for receiving an upper end of the valve guide and may be configured for substantially fluid-tight engagement with the upper end of the valve guide. The valve stem sealing portion may include an annular groove formed in an inner surface of the cylindrical body. The o-ring may be received in the annular groove.

Other features and aspects of this disclosure will be apparent from the following description and the accompanying drawings.

### BRIEF DESCRIPTION OF THE DRAWINGS

FIG. 1 is a schematic cross-sectional view of a combustion engine;

FIG. 2 is schematic cross-sectional view showing an inlet valve and an exhaust valve of the combustion engine of FIG. 1; and

FIG. 3 is a schematic cross-sectional view of a valve stem seal.

### DETAILED DESCRIPTION

The following is a detailed description of exemplary embodiments of the present disclosure. The exemplary embodiment described herein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure may be based in part on the discovery that replacing a valve stem seal of a combustion engine having a first configuration by a valve stem seal having a second configuration, which allows for an increased amount of lubricant to enter a valve guide of an inlet or exhaust valve of a combustion engine, may provide a sufficient amount of lubrication for the valve after operation of the combustion engine over extended periods of time.

Further, using the valve stem seal according to the present disclosure, it may become possible to control the amount of lubrication provided to the valve guide during the service life of a combustion engine. For example, when the combustion engine enters into service, it may be fitted with a valve stem seal such as, for example, a double lip valve stem seal that allows for a relatively small amount of lubricant to enter the valve guides of the valves of the combustion engine. If, however, after an extended period of time of operating the engine, it is found that the amount of lubricant is not sufficient, the factory valve stem seal may be replaced by the valve stem seal according to the present disclosure, thereby increasing an amount of lubricant in the valve guide. To control the amount of lubricant entering the valve guide, the valve stem seal according to the present disclosure may be provided between the valve stem and an upper end of the valve guide. During reciprocation of the valve stem in the valve guide, an amount of lubricant may enter the valve guide via the seal.

In some embodiments, an o-ring valve stem seal as disclosed herein may allow increasing the amount of lubricant supplied to a valve guide in the combustion engine.

Further, in some embodiments, attaching an o-ring valve stem seal to an upper end of the valve guide via an adapter may allow for a more efficient replacement of valve stem seals of a combustion engine.

In some embodiments, it may be possible to change the valve stem seal without changing the valve guide by mounting the o-ring valve stem seal as disclosed herein to the upper end of a valve guide, reducing warranty costs and dealer expense due to lower field activities.

Furthermore, in some embodiments, installing an o-ring in a valve stem seal of a combustion engine may enable adjusting a flow of lubricant in the valve guide to provide a correct amount of lubrication.

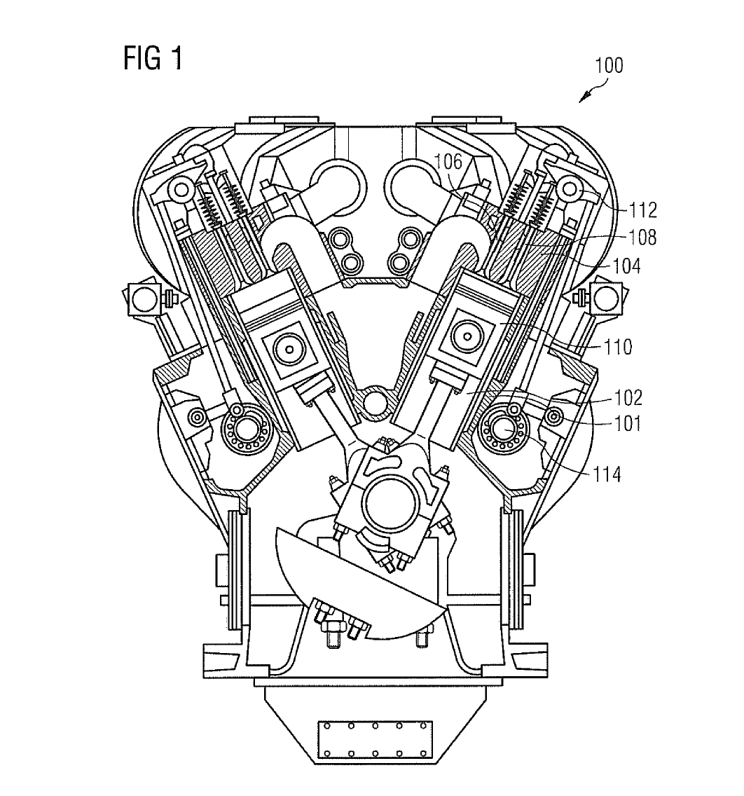

An exemplary embodiment of an internal combustion engine having a valve stem seal is described in the following with reference to FIGS. 1 to 3.

Referring to FIG. 1, an internal combustion engine 100 may include an engine block 101 that at least partially defines a plurality of cylinders 102, a piston 110 slidably disposed within each cylinder 102, and a cylinder head 104 associated with each cylinder 102. Engine 100 may include a plurality of inlet valves 106 and exhaust valves 108 associated with the plurality of cylinders 102. An example of engine 100 may be a natural gas, spark ignited, V-style turbocharged and aftercooled engine that may have, for example, 12 or 16 cylinders, each cylinder having, for example, 2 inlet and 2 exhaust valves. One skilled in the art will recognize that engine 100 may be any other type of internal combustion engines such as, for example, a dual fuel powered engine. Further, engine 100 may include a greater or lesser number of cylinders 102, and cylinders 102 may be disposed in an “in-line” configuration, or in any other suitable configuration.

During operation of engine 100, inlet valves 106 and exhaust valves 108 may open and close to allow a mixture of gas and air to enter each cylinder, and to allow a flow of exhaust to exit each cylinder, respectively.

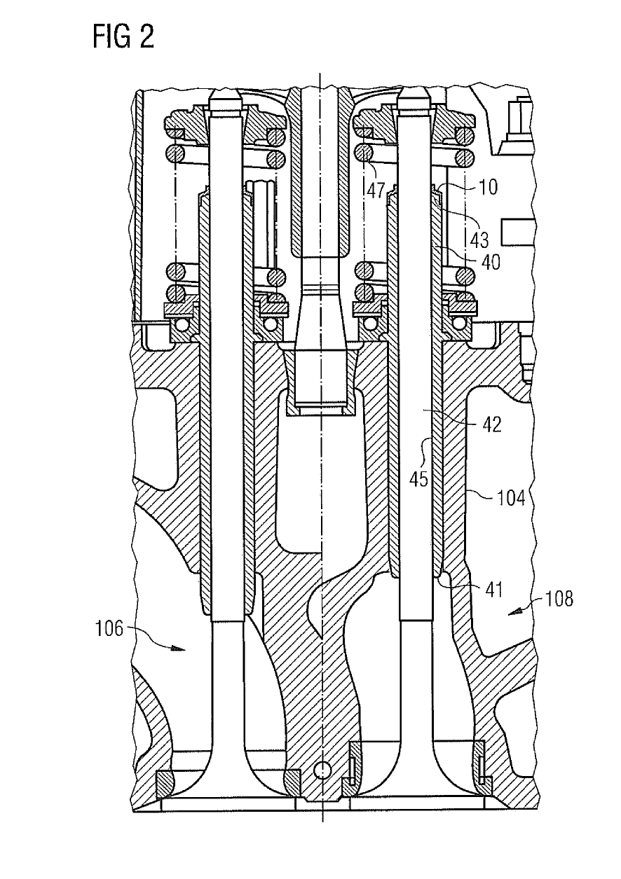

FIG. 2 shows an enlarged cross-sectional view of inlet valve 106 and exhaust valve 108 of combustion engine 100.

Inlet valve 106 and exhaust valve 108 may have a similar configuration, such that only the configuration of exhaust valve 108 will be described in detail in the following. However, it should be appreciated that the same description also applies to inlet valve 106.

Exhaust valve 108 may include a valve guide 40 and a valve stem 42. Valve guide 40 may have an elongated cylindrical shape having a lower end 41, an upper end 43, and a through hole 45. Valve guide 40 may be secured to cylinder head 104 in a known manner.

Valve stem 42 may be disposed in through hole 45 of valve guide 42 such that it may slide inside through hole 45. Valve stem 42 may be biased into a closing position via a biasing spring 47 and may be actuated to move to an opening position via an actuating mechanism 112 connected to, e.g., a camshaft 114 of engine 100 (see FIG. 1). In alternative configurations, a common rail system may be used to actuate the valves.

A valve stem seal 10 (only schematically shown in FIG. 2) may be attached to upper end 43 of valve guide 40 to be in sealing engagement with valve stem 42. Valve stem seal 10 may be configured to allow an amount of lubricant present in a space above cylinder head 104 to enter the inside of valve guide 40 during reciprocating movement of valve stem 42 inside through hole 45 of valve guide 40.

In some types of combustion engines, for example, gas engines, it may be necessary to limit the amount of lubricant entering the valve guide due to relatively stricter emission regulations.

Accordingly, when combustion engine 100 is assembled, valve stem seal 10 may be configured to allow a first amount of lubricant, e.g., oil, to enter valve guide 40 during movement of valve stem 42. For example, the first amount may be a relatively small amount providing a relatively small amount of lubrication for exhaust valve 108, e.g., using valve stem seals such as the ones disclosed in U.S. Pat. No. 5,110,142 and U.S. Pat. No. 4,834,037. After combustion engine 100 has been operated for extended periods of time, for example, 5.000 or 10.000 operating hours, it may be found that the relatively small amount of lubrication may not be sufficient to inhibit wear of the components of exhaust valve 108. Therefore, it may be necessary to increase the amount of lubrication. As such, it may become necessary to replace valve stem seal 10 by another valve stem seal having a second configuration which may allow for a relatively larger amount of lubricant to enter valve guide 40.

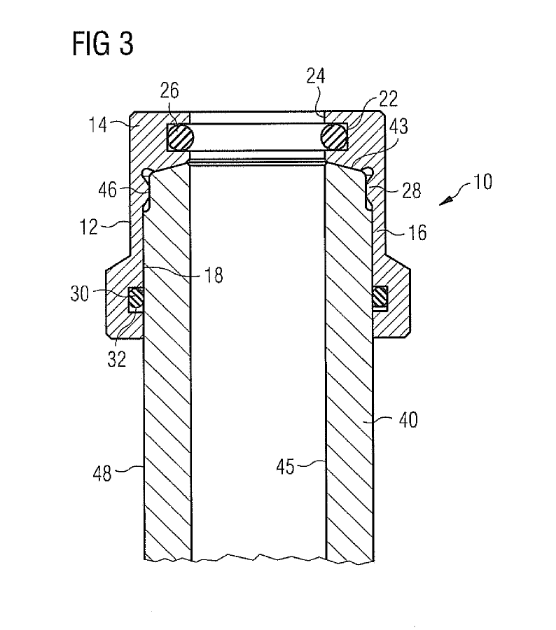

FIG. 3 shows a valve stem seal 10 that may allow for a relatively larger amount of lubricant to enter valve guide 40.

As shown in FIG. 3, valve stem seal 10 may include a cylindrical body 12. Cylindrical body 12 may, for example, be cup-shaped. Cylindrical body 12 may, for example, be made of metal. Cylindrical body 12 may include a mounting portion 16 and a valve stem sealing portion 14. Mounting portion 16 and valve stem sealing portion 14 may be integrally formed with each other, for example, to provide rigidity and stability and allow for easy installation of the valve stem seal assembly, for example, by press-fitting.

Mounting portion 16 may define an opening 18 on one side of cylindrical body 12, and may include one or more convex engagement portions 28 protruding from an inner surface of cylindrical body 12 into opening 18.

Opening 18 may be configured to receive upper end 43 of valve guide 40. Convex engagement portion(s) 28 may protrude into opening 18 and may be configured to engage with a reduced diameter portion 46 formed on upper end 43 of valve guide 40. In some embodiments, reduced diameter portion 46 may be a groove formed in valve guide 40.

Mounting portion 16 may be configured for substantially fluid-tight engagement with upper end 43 of valve guide 40 via engagement portion 28. For example, mounting portion 16 may be attached to valve guide 40 by press-fitting or the like. For example, opening 18 may have an inner diameter that may be somewhat smaller that an outer diameter of valve guide 40. For example, inner diameter of opening 18 may be smaller than outer diameter of valve guide 40 by around 0.5% such that mounting portion 16 may deform slightly during press-fitting of valve stem seal 10 to valve guide 40, resulting in a secure and substantially fluid-tight connection of valve stem seal 10 to valve guide 40.

In some embodiments, mounting portion 16 may further include an o-ring 30 installed in an annular groove 32 formed inside opening 18. O-ring 30 may be configured for sealing engagement with an outer surface of valve guide 40 to contribute to the fluid-tight sealing between valve guide 40 and valve stem seal 10. In particular, o-ring 30 may be configured to prevent blow-by of, e.g., exhaust, which may result in lubricant on inner surface 45 of valve guide 40 being pushed upward, leaving part of valve guide 40 without sufficient lubrication.

Valve stem sealing portion 14 may include an annular groove 22 formed in an inner surface 24 of cylindrical body 12, and an o-ring 26 received in annular groove 22.

Valve stem sealing portion 14 may be configured to allow for at least a predetermined amount of lubricant, e.g., oil, to enter valve guide 40 during reciprocation of valve stem 42 in valve guide 40. The predetermined amount may depend on several factors, for example, wear of the valve stem and/or the valve guide, emission regulations, operating hours of the engine, operating conditions, an operating environment, etc. In some embodiments, the predetermined amount may be larger than, for example, in the embodiments disclosed in, e.g., U.S. Pat. No. 5,110,142 and U.S. Pat. No. 4,834,037.

O-ring 26 may be configured for sealing engagement with valve stem 42 (not shown), which reciprocates in valve guide 40. O-ring 26 may be made of an elastic material such as fluoropolymer rubber (FPM). O-ring 26 may be formed as a ring having a circular cross-section and a constant thickness of, e.g., around 5 mm and a diameter of, for example, 26 mm.

Annular groove 22 may be configured to allow for movement of o-ring 26 in an axial direction of cylindrical body 12 during reciprocation of valve stem 42 in valve guide 40. For example, if o-ring 26 has a thickness of around 5 mm, annular groove 22 may, for example, have a height in the axial direction of cylindrical body 12 of around 5.3 mm. Accordingly, o-ring 26 may roll inside annular groove 22 during reciprocation of valve stem 42, thereby delivering the predetermined amount of lubricant, e.g., oil, to the inside of valve guide 40.

### INDUSTRIAL APPLICABILITY

The valve stem seal of the present disclosure may have a wide application in a plurality of engine types including, for example, gas engines and dual fuel powered engines. The disclosed valve stem seal may be implemented in any engine that utilizes a first valve stem seal configuration to limit the amount of lubricant entering a valve guide of an inlet or exhaust valve in the engine in view of emission regulations. After operating such a combustion engine over an extended period of time, it may become necessary to increase the amount of oil that enters the valve guide via the oil stem seal to inhibit or react to wear of, for example, the valve guide and/or the valve stem.

According to one exemplary method of adjusting lubrication of an inlet or exhaust valve of such a combustion engine, a first valve stem seal, for example, a factory valve stem seal, may be removed from an upper end of the valve guide, and then the valve stem seal of the present disclosure may be attached to the upper end of valve guide to allow a relatively larger amount of lubricant to enter the valve guide during reciprocation of the valve stem.

As such, the present disclosure may provide a retrofitting method for a combustion engine such as, for example, a gas engine, that may allow for an adjustment of the lubrication provided for inlet or exhaust valve of the engine in a sufficient manner.

By installing the o-ring inside cylindrical body 12, which may be integrally formed, and press-fitting cylindrical body 12 to upper end 43 of valve guide 40 (see FIG. 3), it may not be necessary to remove valve guide 40 from engine 100 during replacement. Instead, only a cover portion disposed over cylinder head 104 (see FIG. 1) may have to be removed to replace the valve stem seal. Thus, the amount of time and manpower for replacing, for example, all the valve stem seals in combustion engine 100, may be significantly reduced, reducing warranty costs and dealer expenses due to lower field activities.

Further, after the valve stem seal 10 has been installed in the combustion engine 100, the lubrication provided by the seal may be monitored at regular intervals, and, if necessary, the valve stem seal may again be replaced to increase or decrease an amount of lubricant supplied to the valve guide. For example, the configuration of the valve stem seal may be adjusted to result in a desired amount of lubrication, for example, by selecting an appropriate size o-ring having a particular diameter and/or cross-section.

In addition, in case of wear or damaging of the o-ring, o-ring 26 in the valve stem seal according to the present disclosure may be easily replaced.

As used herein, the term “internal combustion engine” may refer to internal combustion engines such as, for example, gas engines, which may be used as main or auxiliary engines of stationary power providing systems such as power plants for powering pipeline transmission, processing, or gas storage and withdrawal, as well as for generating electricity. Fuel for the internal combustion engines may include natural gas, a combination of natural gas and another fuel, for example, diesel fuel, and the like.

Examples of internal combustion engines for the herein disclosed implementation of the valve stem seal may include, for example, V-type engines of the series GCM34 manufactured by Caterpillar Motoren GmbH & Co. KG, Kiel, Germany, operated in the range of 450-750 rpm. Such internal combustion engines may be large stand-alone engines that may provide easy access to the inlet and exhaust valves of the combustion engine for attachment of the valve stem seal of the present disclosure.

Although the preferred embodiments of this disclosure have been described herein, improvements and modifications may be incorporated without departing from the scope of the following claims.

What is claimed is:

1. A valve stem seal for a combustion engine, comprising:
a cylindrical body including a mounting portion and a valve stem sealing portion integrally formed with the mounting portion, the valve stem sealing portion including an annular groove formed in an inner surface of the cylindrical body; and
an o-ring configured for sealing engagement with a valve stem reciprocating in a valve guide of a valve of the combustion engine,
wherein the mounting portion defines an opening for receiving an upper end of the valve guide and is configured for substantially fluid-tight engagement with the upper end of the valve guide, and the o-ring is received in the annular groove.

2. The valve stem seal according to claim 1, wherein the valve stem sealing portion is configured to allow for at least a predetermined amount of lubricant to enter the valve guide during reciprocation of the valve stem in the valve guide.

3. The valve stem seal according to claim 1, wherein the o-ring is provided in the annular groove with a clearance to roll in the axial direction of the cylindrical body during reciprocation of the valve stem in the valve guide.

4. The valve stem seal according to claim 1, wherein the o-ring is made of an elastic material such as fluoropolymer rubber and has a thickness of around 5 mm and a diameter of around 26 mm.

5. The valve stem seal according to claim 1, wherein the cylindrical body is configured to be attached to the valve guide by press-fitting.

6. The valve stem seal according to claim 5, wherein the mounting portion includes at least one convex engagement portion protruding from on an inner surface of the cylindrical body and configured to engage with a reduced diameter portion of the valve guide during press-fitting of the cylindrical body to the valve guide.

7. The valve stem seal according to claim 1, wherein the o-ring is a first o-ring, and the mounting portion includes a second o-ring configured for sealing engagement with an outer surface of the valve guide to prevent blow-by.

8. The valve stem seal according to claim 1, wherein the cylindrical body is made of metal.

9. A combustion engine comprising:
an engine block at least partially defining a plurality of cylinders, each of the plurality of cylinders being associated with at least one inlet valve and at least one exhaust valve; and
a valve stem seal attached to at least one of the inlet valves and the exhaust valves of the plurality of cylinders, the valve stem seal comprising:
a cylindrical body including a mounting portion and a valve stem sealing portion integrally formed with the mounting portion, the valve stem sealing portion including an annular groove formed in an inner surface of the cylindrical body; and
an o-ring configured for sealing engagement with a valve stem reciprocating in a valve guide of a valve of the combustion engine,
wherein the mounting portion defines an opening for receiving an upper end of the valve guide and is configured for substantially fluid-tight engagement with the upper end of the valve guide, and the o-ring is received in the annular groove.

10. The combustion engine according to claim 9, wherein the valve stem sealing portion is configured to allow for at least a predetermined amount of lubricant to enter the valve guide during reciprocation of the valve stem in the valve guide.

11. The combustion engine according to claim 9, wherein the o-ring is provided in the annular groove with a clearance to roll in the axial direction of the cylindrical body during reciprocation of the valve stem in the valve guide.

12. The combustion engine according to claim 9, wherein the o-ring is made of an elastic material such as fluoropolymer rubber and has a thickness of around 5 mm and a diameter of around 26 mm.

13. The combustion engine according to claim 9, wherein the cylindrical body is configured to be attached to the valve guide by press-fitting.

14. The combustion engine according to claim 13, wherein the mounting portion includes at least one convex engagement portion protruding from on an inner surface of the cylindrical body and configured to engage with a reduced diameter portion of the valve guide during press-fitting of the cylindrical body to the valve guide.

15. The combustion engine according to claim 9, wherein the o-ring is a first o-ring, and the mounting portion includes a second o-ring configured for sealing engagement with an outer surface of the valve guide to prevent blow-by.

16. A method of adjusting lubrication of an inlet or exhaust valve in a combustion engine, the inlet or exhaust valve including a valve guide and a valve stem slidably disposed in the valve guide, comprising:
removing a first valve stem seal from an upper end of the valve guide, the first valve stem seal being configured to allow a first amount of lubricant to enter the valve guide during reciprocation of the valve stem; and
attaching a second valve stem seal to the upper end of the valve guide, the second valve stem seal being configured to allow a second amount of lubricant that is greater than the first amount to enter the valve guide during reciprocation of the valve stem, thereby increasing an amount of lubricant in the valve guide.

17. The method of claim 16, wherein the second valve stem seal comprises:
a cylindrical body including a valve stem sealing portion and a mounting portion integrally formed with each other, the mounting portion defining an opening for receiving the upper end of the valve guide and being configured for substantially fluid-tight engagement with the same, the valve stem sealing portion including an annular groove formed in an inner surface of the cylindrical body; and
an o-ring received in the annular groove and configured for sealing engagement with the valve stem reciprocating in the valve guide.

18. The method according to claim 16, further including selecting a size of the o-ring to allow for a predetermined amount of lubricant to enter the valve guide.

19. The method according to claim 16, further including attaching the second valve stem seal to the upper end of the valve guide by press-fitting.

20. The method according to claim 16, further including:
removing the second valve stem seal;
replacing the o-ring of the second valve stem seal; and
re-attaching the second valve stem seal.
